(19) United States
(12) Patent Application Publication
(10) Pub. No.: US 2023/0373859 A1
(43) Pub. Date: Nov. 23, 2023

(54) POZZOLAN BASED CEMENT AND METHOD OF MAKING AND USING SAME

(71) Applicant: Comus Construction, LLC, Woodsboro, MD (US)

(72) Inventor: Brad Hill, Woodsboro, MD (US)

(21) Appl. No.: 18/199,128

(22) Filed: May 18, 2023

Related U.S. Application Data
(60) Provisional application No. 63/343,995, filed on May 19, 2022.
(60) Provisional application No. 63/389,635, filed on Jul. 15, 2022.
(60) Provisional application No. 63/467,143, filed on May 17, 2023.

(51) Int. Cl. C04B 28/02; C04B 7/13; C04B 7/52; C04B 28/04; C04B 28/14

(52) U.S. Cl. CPC C04B 28/021; C04B 7/13; C04B 7/527; C04B 28/04; C04B 28/14; C04B 2103/10

(57) ABSTRACT

A process to enhance the pozzolanic activity of a natural inactive sedimentary pozzolan and the pozzolanic material formed by the process are described. The process comprises the steps of finely dividing the pozzolan to a Blaine fineness of at least 8,000 cm²/g for increasing the surface area of the finely ground pozzolan and exposing a great amount of the number of silicon and aluminum atoms available to react with lime in a pore solution.

### CROSS-REFERENCES TO RELATED APPLICATIONS

This application claims the benefit of U.S. Provisional Application No. 63/343,995, filed May 19, 2022, and U.S. Provisional Application No. 63/389,635, filed Jul. 15, 2022, and U.S. Provisional Application No. 63/467,143, filed May 17, 2023, the contents of all of which are incorporated herein in their entirety.

### BACKGROUND

A process is described for activating a sub-class of mineral pozzolans and, more particularly, activation of non-volcanic mineral pozzolans is achieved by finely dividing the mineral pozzolans for use in making cement for the production of concrete.

Concrete is a material that is used worldwide in today's construction industry for buildings and roads, and millions of tons of concrete are poured in the United States alone each year. Modern concrete is comprised of gravel, sand, Portland cement, mineral admixtures, chemical admixtures and water. The production of Portland cement and some mineral admixtures create CO₂ emissions. Consequently, the millions of tons of concrete produced annually adding a considerable amount of CO₂ into the atmosphere.

Portland cement is produced by heating a mixture of raw materials, one of which is a form of calcium carbonate and an aluminum silicate, most typically a limestone and clay or shale. The process of cement manufacture consists of blending the raw materials, burning the mixture in a kiln to form a clinker, and grinding the clinker with the addition of a small amount of gypsum to a fine powder. Upon calcination, each ton of limestone produces 880 pounds of CO₂ and 1120 pounds of CaO. The CaO will combine with silicon dioxide, aluminum oxide and iron oxide to form almost a ton of Portland cement. The fossil fuel that heats the kiln also contributes CO₂ from its combustion so that it has been estimated that a ton of CO₂ is produced for each ton of Portland cement produced.

Typical mineral admixtures used in the production of concrete include active natural pozzolans, coal fly ash and ground, granulated blast furnace slag. The primary function of mineral admixtures is to chemically react with the lime produced during the hydration of Portland cement, which makes Portland cement less durable, to produce calcium aluminosilicate hydrates. This reduces the lime content of the concrete and creates a stronger and more durable concrete.

Coal fly ash produced by combustion of coal in electric power plants is the most used pozzolan material in today's concrete products. However, changes in the electric power industry have reduced the amount of coal fly ash produced as natural gas and biomass are being used more as fuels, and solar, wind and hydroelectric generation has increased. Additionally, the coal fly ash that is produced is of poor quality because of increasingly stricter environmental constraints. Moreover, combustion of coal produces CO₂ from the carbon combustion. Each ton of coal with a typical ash content of 10% produces about three and one third tons of CO₂. Since fly ash accounts for about 80% of the ash produced, about four tons of CO₂ are produced for each ton of fly ash produced.

Blast-furnace slag also releases CO₂ into the atmosphere during its production. Two and one half to three and one half tons of blast-furnace gas are generated per ton of pig iron produced. The percentage of CO and CO₂ in blast-furnace gas is directly related to the amount of carbon in coke and the amount of CO₂ in the limestone charged per ton of pig iron. Generally, the amount of CO plus CO₂ is 1.0 to 1.4 tons per ton of iron produced, with CO₂ being roughly half. There are 444 pounds of blast-furnace slag produced per ton of iron produced. Therefore, the amount of CO₂ produced per ton of blast-furnace slag produced will be roughly 4 times that amount, or about 2 tons.

Active natural mineral pozzolans are a green solution as a mineral admixture for use in the production of concrete. The first discovery of active pozzolan materials was near the base plane of a volcano. Volcanic pozzolan minerals were made active by the heat of the volcano. The active pozzolanic minerals were deposited at various distances from the volcano, separated in size by the air column activity of the volcanic winds. While most natural pozzolans are for the most part of volcanic origin, other sources include trass, Santorin earth, clays, diatomaceous earth, opaline cherts and shales, tuffs, and each may or may not require calcination. It is generally agreed that the siliceous component of a pozzolan should be in an amorphous or non-crystalline state, such as glass, opal, or thermally altered clay for best results. Crystalline siliceous materials, such as quartz, even in finely divided form are quite inactive.

Active non-volcanic pozzolan materials usually require treatment to produce a material that meets ASTM and AASHTO specifications for a mineral admixture for use in concrete. Manmade activation of pozzolans typically occurs through the use of “artificial volcanos” called calciners. Particle gradation is achieved through the use of air classifiers, replicating the air column activity of volcanic winds. Of course, the calciners produce CO₂ emissions such that the environmental impact of activating the pozzolan materials negates the economic advantages.

A method of activation for natural mineral pozzolans which minimizes CO₂ emission is needed due to the shortage of good quality coal fly ash and the need to reduce the carbon footprint of concrete production. Natural, sedimentary, inactive pozzolans represent a source of pozzolanic materials when these pozzolans are activated.

### SUMMARY

A process is provided for enhancing the pozzolanic activity of a natural, sedimentary, inactive mineral pozzolan. The process comprises the steps of finely dividing the pozzolan material to a Blaine fineness of at least 8,000 cm²/g for increasing the surface area of the finely divided pozzolan and exposing a great amount of the number of silicon and aluminum atoms available to react with lime in a pore solution. The process may further comprise a chemical accelerator, wherein the chemical accelerator is selected from calcium chloride, calcium nitrate, potassium chloride, potassium sulfate, and mixtures thereof.

In one aspect, the process further comprises the step of blending the finely divided pozzolan with cement kiln dust having an amount of potassium sulfate or potassium chloride for accelerating the setting time and increasing the early strength gain. In another aspect, the process further comprises the step of blending the finely divided pozzolan with other pozzolanic materials. The finely divided pozzolan may be selected from coal ash from conventional or fluidized-bed combustion (FBC) boilers to include the fly ash, bottom or bed ash, and the landfilled ash, clays, bagasse ash, rice husk ash, waste glass, blast furnace slag, metakaolin, silica fume and mixtures thereof.

A method is also provided for making a cementitious material. The method comprises the steps of finely dividing a natural sedimentary inactive pozzolan to a Blaine fineness of at least 8,000 cm²/g for increasing the surface area of the finely divided pozzolan and exposing a great amount of the number of silicon and aluminum atoms available to react with lime in a pore solution and adding the finely divided pozzolan as a mineral admixture to a concrete.

A method is further provided for making a blended cement. The method comprises the steps of finely dividing a natural sedimentary inactive pozzolan to a Blaine fineness of at least 8,000 cm²/g for increasing the surface area of the finely divided pozzolan and exposing a great amount of the number of silicon and aluminum atoms available to react with lime in a pore solution and adding the finely divided pozzolan to Portland cement.

Another method of making a blended cement comprises the steps of finely dividing a natural sedimentary inactive pozzolan to a Blaine fineness of at least 8,000 cm²/g for increasing the surface area of the finely divided pozzolan and exposing a great amount of the number of silicon and aluminum atoms available to react with lime in a pore solution, and forming a mixture of the finely divided pozzolan, Portland cement clinker, and the optimum amount of gypsum.

A pozzolanic material comprises a finely divided natural sedimentary inactive pozzolan having a Blaine fineness of at least 8,000 cm²/g. In one aspect, the pozzolanic material further comprises a chemical accelerator, wherein the chemical accelerator is selected from calcium chloride, calcium nitrate, potassium chloride, potassium sulfate, and mixtures thereof. In another aspect, the pozzolanic material further comprises cement kiln dust having an amount of potassium sulfate or potassium chloride for accelerating the setting time and increasing early strength gain. In another aspect, the pozzolanic material further comprises other pozzolanic materials, wherein the finely divided pozzolan is selected from coal ash from conventional or fluidized-bed combustion (FBC) boilers to include the fly ash, bottom or bed ash, and the landfilled ash, clays, bagasse ash, rice husk ash, waste glass, blast furnace slag, metakaolin, silica fume and mixtures thereof.

A cementitious material comprises a natural sedimentary active pozzolan having a Blaine fineness of at least 8,000 cm²/g for increasing the surface area of the finely divided pozzolan and exposing a great amount of the number of silicon and aluminum atoms available to react with lime in a pore solution; and a concrete.

A first blended cement comprises an active sedimentary natural pozzolan having a Blaine fineness of at least 8,000 cm²/g for increasing the surface area of the finely divided pozzolan and exposing a great amount of the number of silicon and aluminum atoms available to react with lime in a pore solution, and a Portland cement. A second blended cement comprises an active sedimentary natural pozzolan having a Blaine fineness of at least 8,000 cm²/g for increasing the surface area of the finely divided pozzolan and exposing a great amount of the number of silicon and aluminum atoms available to react with lime in a pore solution, Portland cement clinker, and gypsum.

A method is also provided for making an object or structure. The method comprises the steps of placing in a form or a mold, a cementitious based material comprising an active sedimentary natural pozzolan having a Blaine fineness of at least 8,000 cm²/g for increasing the surface area of the finely divided pozzolan and exposing a great amount of the number of silicon and aluminum atoms available to react with lime in a pore solution, a hydraulic cement, and water sufficient to hydrate the cementitious material, and allowing the cementitious material to at least partially cure.

An object or structure made from a cementitious material comprises a hydraulic cement and an active sedimentary natural pozzolan having a Blaine fineness of at least 8,000 cm²/g for increasing the surface area of the finely divided pozzolan and exposing a great amount of the number of silicon and aluminum atoms available to react with lime in a pore solution.

### DESCRIPTION

As used herein, the term “pozzolan” refers to a siliceous, or siliceous and aluminous, material which, in itself, possesses little or no cementitious value, but which will, when activated, in finely divided form and in the presence of water, react chemically with calcium hydroxide at ordinary temperature to form compounds possessing cementitious properties.

As used herein, the term “raw pozzolan” refers to an inactive mineral pozzolan.

As used herein, the term “active pozzolan” refers to a pozzolan which has been activated to chemically react in the presence of water, with calcium hydroxide at ordinary temperature to form compounds possessing cementitious properties that greatly improve concrete durability and performance. The quantification of the capacity of a pozzolan to react with calcium hydroxide and water is given by measuring its pozzolanic activity.

As used herein, the term “inactive pozzolan” refers to a pozzolan which has not been activated to react, in the presence of water, with calcium hydroxide at ordinary temperature to form compounds possessing cementitious properties that greatly improve concrete durability and performance.

As used herein, the term “calcined pozzolan” refers to a pozzolan which has been artificially heated in a calciner (kiln).

As used herein, the term “artificial pozzolan” refers to a pozzolan which has been heated in a calciner (kiln).

As used herein, the term “volcanic pozzolan” refers to a pozzolan which has passed through a volcano.

As used herein, the term “natural pozzolan” refers to a pozzolan which is not manmade.

As used herein, the term “mineral” refers to a solid inorganic substance of natural occurrence.

As used herein, the term “sedimentary deposit” refers to erosion detritus deposited naturally by the action of water in oceans and lakes. This will appear as layered clays, silts, and sands which transition after significant time to stone such as shale, slate, siltstone, or sandstone.

As used herein, the term “portland cement” refers to a manmade cementitious material made by heating limestone in the presence of a high silica mineral yielding mostly tricalcium silicate.

As used herein, the term “pozzolan portland cement” refers to a manmade cementitious material made by blending 60% portland cement with 40% active pozzolan.

Applicant owns the mineral rights in a quarry near Woodsboro, Maryland, which produces sand, gravel, and decorative stone. During the processing of these materials, aggregate fines (≤⅜″) are generated which, when finely divided, produces a good quality natural active sedimentary pozzolan which can be used as a mineral admixture for concrete, blended with Portland cement, or interground with clinker and the optimum amount of gypsum to produce a 1P blended cement. The blended cement made by the Applicant, along with the sand and gravel, can be used to make a concrete for a precast operation for making concrete pipes and the like.

Geologically speaking, the quarry is located in the Araby formation, which is comprised of about 330 feet of greenish gray phyllite and very fine-grained metasiltstone with traces of horizontal and vertical burrows. It has also been described as gray and tan siltstone and silty shale with layers of dark gray to black, fine to medium-grained quartzite. Black slaty shale or phyllite was designated as the overlying Cash Smith Formation. The Araby Formation mapped in the northwest corner of the Westminster terrace in Carroll County is grayish metasiltstone. All of these minerals are known inactive natural sedimentary pozzolans.

The mineralogical compositions of these raw natural pozzolans were determined by x-ray diffraction analyses and the results are given below. Sample 24350 is Cash Smith shale. Sample 24352 is Araby Brown and Blue mix.

| | | Approximate Wt. % | |
|---|---|---|---|
| | | Sample | Sample |
| Mineral Name | Chemical Formula | 24350 | 24352 |
| Quartz | SiO₂ | 18 | 24 |
| K-feldspar | KalSi₃O₈ | 5 | 37 |
| Plagioclase feldspar | (Na,Ca)Al(Si,Al)₃O₈ | — | 13 |
| Mica/illite | (K,Na,Ca)(Al,Mg,Fe)₂(Si,Al)₄O₁₀(OH,F)₂ | 60 | 16 |
| Chlorite | (Mg,Fe,Al)₆(Si,Al)₄O₁₀(OH) | 7 | <5 |
| Calcite | CaCO₃ | 9 | <5 |
| Pyrite | FeS₂ | <2 | — |
| Unidentified | ? | <5 | <5 |

The raw natural pozzolans were rendered active by the process as described herein. The chemical and physical analyses of these now active sedimentary natural pozzolans are given below along with the respective ASTM and AASHTO specifications:

| | Results | | | |
|---|---|---|---|---|
| | Sample | Sample | Specification N | |
| Chemical Analysis: Ignited basis | 24350 | 24352 | ASTM C618 AASHTO M295 | |
| Silicon Dioxide, SiO₂, % | 54.53 | 66.89 | — | |
| Aluminum Oxide, Al₂O₃, % | 20.01 | 15.31 | — | |
| Iron Oxide, Fe₂O₃, % | 8.05 | 4.39 | — | |
| Sum of SiO₂, Al₂O₃, Fe₂O₃, % | 82.59 | 86.59 | 70.0 | Min |
| Calcium Oxide, CaO, % | 5.43 | 1.47 | — | |
| Magnesium Oxide, MgO, % | 2.04 | 1.19 | — | |
| Sodium Oxide, Na₂O, % | 0.38 | 1.37 | — | |
| Potassium Oxide, K₂O, % | 7.31 | 8.02 | — | |
| Sulfur Trioxide, SO₃, % | 0.91 | 0.11 | 4.0 | Max |
| Moisture Content, % | 0.30 | 0.34 | 3.0 | Max |
| Loss on Ignition, % | 6.41 | 2.19 | 10.0 | Max |
| Physical Analysis: | | | | |
| Amount Retained on a 325 Sieve, % | 15.1 | 1.5 | 34 | Max |
| Blaine Fineness, cm²/g | 10,350 | 9,560 | — | |
| Strength Activity Index | | | | |
| Portland Cement @ 7 days, % Control | 87 | 85 | 75 | Min |
| Portland Cement @ 28 days, % Control | 83 | 84 | 75 | Min |
| Water Requirement, % of Control; | 100 | 100 | 115 | Max |
| Autoclave Expansion, % | −0.00 | −0.02 | 0.8 | Max |

| | | | |
|---|---|---|---|
| Density | 2.77 | 2.65 | — |
| Reactivity with Cement Alkalis, % | | | |
| Reduction of Mortar Expansion, % | | 75 | |

As can be seen by these results, both active natural sedimentary pozzolans prepared by the process as described herein meet the specifications for a natural pozzolan for use in concrete.

Accordingly, a method is provided for enhancing the pozzolanic activity of inactive natural sedimentary pozzolans. The method comprises finely dividing the minerals so as to increase the surface area of the material as measured by the Blaine fineness to a number greater than 8,000 cm²/g. Any apparatus or method known in the art may be used for finely dividing the mineral pozzolans, including ball mills, vertical roller mills, horizontal mills, hammer mills, jet mills or combinations thereof. While not intending to be bound by theory, it is believed that a pozzolan material includes active receptor particle sites scattered along the surface of the pozzolan material. The active receptor sites on the surface create the desired reaction. The process as described herein converts inactive pozzolan material into a reactive pozzolan material by exposing more active receptor particle sites. By milling the mineral pozzolan material into finer sized particles, more receptor particle sites become a part of the exposed surfaces. The milling step produces finer particles thereby increasing the surface area of the pozzolan material and exposing more receptor particle sites. The process may be repeated such that each milling iteration exposes more reactive receptor particle sites until the pozzolan material is classified as active.

In one aspect, the process increases the number of silicon and aluminum atoms on the surface and available to react with lime in the concrete pore water and form additional cementitious products. This phenomenon can occur whether the now active natural sedimentary pozzolan is added as a mineral admixture to the concrete, incorporated into a blended cement by adding the fine active pozzolan powder with Portland cement, or inter-grinding the active natural sedimentary pozzolan with Portland cement clinker and gypsum.

The pozzolanic activity of active natural sedimentary pozzolan can also be increased by the use of chemical admixtures known as set accelerators. Calcium chloride is an accelerator most commonly used in the industry. Calcium nitrate and potassium chloride are also good accelerators as well as a host of other alkali and alkaline earth chlorides and sulfates. Cement kiln dust is also a suitable accelerator because it often contains a good quantity of potassium sulfate or potassium chloride. These accelerating agents can be added to a concrete mix separately or incorporated into the blended cement product during the blending or grinding process.

The pozzolanic activity of active natural sedimentary pozzolan can also be increased by blending the material with other pozzolans or materials that enhance the pozzolanic process. It has been observed that cement kiln dust will increase the early strength of concrete containing pozzolans due to the accelerating effect of the potassium sulfate or potassium chloride found in these kiln dusts. Other pozzolanic candidates are coal ashes, including fly ash, bottom ash and landfilled ash (also known as harvest ash when processed) from conventional or fluidized-bed combustion (FBC) boilers. There are several FBC power plants in the Pennsylvania area that burn waste coal (both anthracitic and bituminous) and make an excellent pozzolan when properly treated by sizing and mailing. Some clays have also been shown to have good pozzolanic properties as well as waste bricks. Bagasse ash from sugar mills has also been proven to be an excellent pozzolan by research in Florida DOT laboratories. Other pozzolans include rice husk ash, waste glass, blast furnace slag, metakaolin, and silica fume.

In addition to increasing the pozzolanic activity of the natural sedimentary pozzolan, the durability of the concrete made from this mineral admixture can be enhanced by the addition of other chemical admixtures. Air-entraining agents such as vinsol resin can be added to the concrete separately or as an ingredient to be interblended or interground as a 1P cement for freeze-thaw protection of the concrete. Water-reducing agents of various forms provide a concrete with a lower water-to-cementitious material ratio, which produces a stronger and more durable concrete. Again, these items can be added separately to the concrete or used as grinding aids in the production of a blended cement.

Although the process is described hereinabove for a natural active sedimentary pozzolan, which can be used as a mineral admixture for concrete, blended with Portland cement, or used to produce a 1P blended cement, other sources of natural pozzolan are suitable. For example, the process can use inactive, natural, sedimentary pozzolan (INSP) and activate this material for use in pozzolan portland cement (PPC) cement. Dredged harbor material (silt) is an INSP that can be activated by use of the process for use in PPC. When dried and finely divided using the process, the dredged harbor material can be added ‘post-kiln’ and inter-ground with portland clinker as a supplementary cementitious material for manufacturing PPC.

The process has many advantages, including that once activated and used in cement, any concrete product made comprising the cement will encapsulate all chemicals contained within the compound. Moreover, the process is a ‘cold’ process that uses fine milling instead of high heat and activation is achieved through the ‘cold’ process. Even when the process is used with materials that are polluted with toxins, there is no out-gassing due to loss on ignition of toxic chemicals as is the case with high-heat activation. Loss of ignition is the loss of chemical residues due to evaporation or combustion during high heat processing (calcining). This “loss” of chemicals must be contained in pollution control devices according to prescribed EPA standards. Thus, toxic pollutants contained in, for example, dredged soil and processed as described herein as a method of activation, remain inert and are encapsulated in the cured PPC. PPC is impervious to water infiltration, making a perfect entombment for these toxins for centuries. Importantly, the process does not require heat as in calcining, and thus no burning of fossil fuels. The process thus provides a sustainable solution to the CO₂ crisis and the short-lived, concrete infrastructure of the world.

I claim:

1. A process to enhance the pozzolanic activity of a natural inactive sedimentary pozzolan, the process comprising the steps of: fine grinding the pozzolan to a Blaine fineness of at least 8,000 cm²/g for increasing the surface area of the milled pozzolan and exposing a great amount of the number of silicon and aluminum atoms available to react with lime in a pore solution.

2. The process to enhance the pozzolanic activity of a natural inactive sedimentary pozzolan as recited in claim 1, further comprising the step of adding a chemical accelerator.

3. The process to enhance the pozzolanic activity of a natural inactive sedimentary pozzolan as recited in claim 2, wherein the chemical accelerator is selected from calcium chloride, calcium nitrate, potassium chloride, potassium sulfate, and mixtures thereof.

4. The process to enhance the pozzolanic activity of a natural inactive sedimentary pozzolan as recited in claim 1, further comprising the step of blending the finely ground pozzolan with cement kiln dust having an amount of potassium sulfate or potassium chloride for accelerating the setting time and increasing the early strength gain.

5. The process to enhance the pozzolanic activity of a natural inactive sedimentary pozzolan as recited in claim 1, further comprising the step of blending the finely ground pozzolan with other pozzolanic materials.

6. The process to enhance the pozzolanic activity of a natural inactive sedimentary pozzolan as recited in claim 5, wherein the finely divided pozzolan is selected from coal ash from conventional or fluidized-bed combustion(FBC) boilers to include the fly ash, bottom or bed ash, and the landfilled ash, clays, bagasse ash, rice husk ash, waste glass, blast furnace slag, metakaolin, silica fume and mixtures thereof.

7. A method of making a cementitious material, the method comprising the steps of:
Finely grinding a natural inactive sedimentary pozzolan to a Blaine fineness of at least 8,000 cm²/g for increasing the surface area of the milled pozzolan and exposing a great amount of the number of silicon and aluminum atoms available to react with lime in a pore solution; and
adding the milled pozzolan as a mineral admixture to a concrete.

8. A method of making a blended cement, the method comprising the steps of: finely grinding natural inactive sedimentary pozzolan to a Blaine fineness of at least 8,000 cm²/g for increasing the surface area of the finely ground pozzolan and exposing a great amount of the number of silicon and aluminum atoms available to react with lime in a pore solution; and adding the finely ground pozzolan to Portland cement.

9. A method of making a blended cement, the method comprising the steps of: finely grinding a natural inactive sedimentary pozzolan to a Blaine fineness of at least 8,000 cm²/g for increasing the surface area of the finely ground pozzolan and exposing a great amount of the number of silicon and aluminum atoms available to react with lime in a pore solution; and forming a mixture of the finely ground pozzolan, Portland cement clinker and the optimum amount of gypsum.

10. A pozzolanic material comprising a finely ground natural inactive sedimentary pozzolan having a Blaine fineness of at least 8,000 cm²/g.

11. The pozzolanic material as recited in claim 10, further comprising a chemical accelerator.

12. The pozzolanic material as recited in claim 11, wherein the chemical accelerator is selected from calcium chloride, calcium nitrate, potassium chloride, potassium sulfate, and mixtures thereof.

13. The pozzolanic material as recited in claim 10, further comprising cement kiln dust having an amount of potassium sulfate or potassium chloride for accelerating the setting time and increasing early strength gain.

14. The pozzolanic material as recited in claim 10, further comprising other pozzolanic materials.

15. The pozzolanic material as recited in claim 14, wherein the finely ground pozzolan is selected from coal ash from conventional or fluidized-bed combustion(FBC) boilers to include the fly ash, bottom or bed ash, and the landfilled ash, clays, bagasse ash, rice husk ash, waste glass, blast furnace slag, metakaolin, silica fume and mixtures thereof.

16. A cementitious material comprising: a natural inactive sedimentary pozzolan having a Blaine fineness of at least 8,000 cm²/g for increasing the surface area of the milled pozzolan and exposing a great amount of the number of silicon and aluminum atoms available to react with lime in a pore solution; and a concrete.

17. A blended cement comprising: a natural inactive sedimentary pozzolan having a Blaine fineness of at least 8,000 cm²/g for increasing the surface area of the finely ground pozzolan and exposing a great amount of the number of silicon and aluminum atoms available to react with lime in a pore solution; and a Portland cement.

18. A blended cement comprising: a natural inactive sedimentary pozzolan having a Blaine fineness of at least 8,000 cm²/g for increasing the surface area of the finely ground pozzolan and exposing a great amount of the number of silicon and aluminum atoms available to react with lime in a pore solution; Portland cement clinker; and gypsum.

19. A method comprising the steps of: placing in a form or a mold a cementitious based material comprising a cementitious material comprising a natural inactive sedimentary pozzolan having a Blaine fineness of at least 8,000 cm²/g for increasing the surface area of the finely ground pozzolan and exposing a great amount of the number of silicon and aluminum atoms available to react with lime in a pore solution; a hydraulic cement; and water sufficient to hydrate the cementitious material; and allowing the cementitious material to cure at least partially.

20. An object or structure made from a cementitious material comprising a hydraulic cement and a natural inactive sedimentary pozzolan having a Blaine fineness of at least 8,000 cm²/g for increasing the surface area of the finely ground pozzolan and exposing a great amount of the number of silicon and aluminum atoms available to react with lime in a pore solution.
